(19) United States
(12) Patent Application Publication
(10) Pub. No.: US 2024/0416784 A1
(43) Pub. Date: Dec. 19, 2024

(54) SUPPLY DEVICE

(71) Applicant: TOYOTA JIDOSHA KABUSHIKI KAISHA, Toyota-shi (JP)

(72) Inventors: Toshiya HASHIMOTO, Miyoshi-shi (JP); Masato MAEMURA, Nisshin-shi (JP); Ryosuke IKEMURA, Susono-shi (JP); Shogo TSUGE, Fuji-shi (JP)

(73) Assignee: TOYOTA JIDOSHA KABUSHIKI KAISHA, Toyota-shi (JP)

(21) Appl. No.: 18/648,996

(22) Filed: Apr. 29, 2024

(30) Foreign Application Priority Data
Jun. 14, 2023 (JP) 2023-098080

(51) Int. Cl. B60L 53/62; B60L 53/12; B60L 53/30; H02J 50/12; H02J 50/80

(52) U.S. Cl. CPC B60L 53/62; B60L 53/12; B60L 53/305; H02J 50/12; H02J 50/80

(57) ABSTRACT

A supply device includes a power transmission device that has a primary coil provided on a road and transmits power to a vehicle traveling on a road in a non-contact manner, and a ground-side control device that controls the power transmission device, wherein the control device compares the required power of the vehicle traveling on the power supply lane provided with the primary coil with the suppliable power supplied by the power transmission device, adjusts the distribution of the supply power from the ground side to the vehicle based on the comparison result, and notifies the vehicle that the supply power from the ground side is insufficient when the suppliable power is smaller than the required power.

### CROSS-REFERENCE TO RELATED APPLICATION

This application claims priority to Japanese Patent Application No. 2023-098080 filed on Jun. 14, 2023, incorporated herein by reference in its entirety.

### BACKGROUND

### 1. Technical Field

The present disclosure relates to a supply device.

### 2. Description of Related Art

Japanese Unexamined Patent Application Publication No. 2011-244532 (JP 2011-244532 A) discloses a non-contact power supply system that transmits power to a vehicle traveling on a road in a non-contact manner. In the configuration described in JP 2011-244532 A, a power supply lane provided with a primary coil includes a plurality of lanes with different supply power, and a vehicle with a battery with a small remaining capacity is instructed to travel in a power supply lane with large supply power.

### SUMMARY

When power is supplied from the ground side to a plurality of vehicles traveling in the power supply lane concurrently, it is conceivable that a supply device on the ground side distributes the supply power to the vehicles. However, there is a limit to the power that can be supplied in the power supply lane. In the power supply lane, the power that can be supplied from the ground side and the situation of each vehicle change individually, and thus the balance between the power demand and the power supply changes due to factors on the ground side and the vehicle side. Therefore, there is room for study on a method of adjusting the distribution of the supply power from the ground side to the vehicles.

The present disclosure has been made in view of the above circumstances, and an object of the present disclosure is to provide a supply device capable of appropriately distributing supply power from the ground side to vehicles traveling in a power supply lane provided with a primary coil.

An aspect of the present disclosure provides a supply device including: a power transmission device that includes a primary coil provided in a road and transmits power to a vehicle traveling on the road in a non-contact manner; and a control device on a ground side that controls the power transmission device, in which the control device is configured to: compare required power for the vehicle traveling in a power supply lane provided with the primary coil and suppliable power to be supplied by the power transmission device; adjust distribution of supply power from the ground side to the vehicle based on a comparison result; and notify the vehicle that the supply power from the ground side is insufficient when the suppliable power is less than the required power.

According to this configuration, it is possible to notify the vehicle traveling in the power supply lane that the supply power on the ground side is insufficient based on the required power for the vehicle and the suppliable power that can be supplied by the power supply device on the ground side. In the vehicle that has received this notification, the driver can be informed in advance that the supply power to be supplied by the supply device is insufficient in a power supply section to be entered, by checking the notification.

In addition, the control device may be configured to: when the required power is received from a plurality of vehicles traveling in the power supply lane, determine whether a sum of the required power is greater than the suppliable power; and when it is determined that the sum of the required power is greater than the suppliable power, calculate allocated power for each vehicle and notify the vehicle of the allocated power.

According to this configuration, it is possible to notify the vehicle traveling in the power supply lane in advance of the allocated power corresponding to the required power for the vehicle and the suppliable power that can be supplied by the supply device on the ground side.

In addition, the power supply lane may include a plurality of lanes; and the control device may be configured to when it is determined that the sum of the required power is greater than the suppliable power, calculate allocated power for the vehicle in a current lane and allocated power for the vehicle in a different lane from the current lane, when the allocated power in the different lane is greater than the allocated power in the current lane, transmit information that suggests a change to the different lane to the vehicle, and when the allocated power in the different lane is less than or equal to the allocated power in the current lane, notify the vehicle of the allocated power in the current lane.

According to this configuration, when the power supply lane includes a plurality of lanes, it is possible to compare the allocated power in the current lane and the allocated power in the different lane, and to notify the vehicle of information corresponding to the comparison result.

In addition, the control device may be configured to set distribution of the supply power based on a physical size of the vehicle and a state of charge (SOC) of a battery mounted on the vehicle.

According to this configuration, it is possible to adjust the distribution of the supply power according to the situation of the vehicle traveling in the power supply lane.

According to the present disclosure, it is possible to notify the vehicle traveling in the power supply lane that the supply power on the ground side is insufficient based on the required power for the vehicle and the suppliable power that can be supplied by the power supply device on the ground side. In the vehicle that has received this notification, the driver can be informed in advance that the supply power to be supplied by the supply device is insufficient in a power supply section to be entered, by checking the notification.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic illustrating a wireless power transfer system according to an embodiment;

FIG. 2 is a diagram illustrating a configuration of a wireless power transfer system;

FIG. 3 is a schematic diagram for describing wide area radio communication in a wireless power transfer system;

FIG. 4 is a diagram illustrating a functional of a power transmission ECU;

FIG. 5 is a diagram for describing a functional configuration of a vehicle ECU;

FIG. 6 is a diagram for describing a power transfer process;

FIG. 7 is a diagram illustrating a case of performing communication using wide area radio communication between vehicles and a supply device;

FIG. 8 is a diagram illustrating an operation after the power supply during traveling from the supply device to the vehicles is completed;

FIG. 9 is a diagram for describing radio communication performed between vehicles traveling on a power supply lane and a supply device on the ground side;

FIG. 10 is a flow chart diagram showing a control flow when the power supply lane is a single lane;

FIG. 11 is a diagram for describing radio communication performed between vehicles traveling in a power supply lane including a plurality of lanes and a ground-side supply device; and

FIG. 12 is a flow chart illustrating a control flow when the power supply lane is a plurality of lanes.

### DETAILED DESCRIPTION OF EMBODIMENTS

Hereinafter, a supply device according to an embodiment of the present disclosure will be described in detail. The present disclosure is not limited to the embodiments described below.

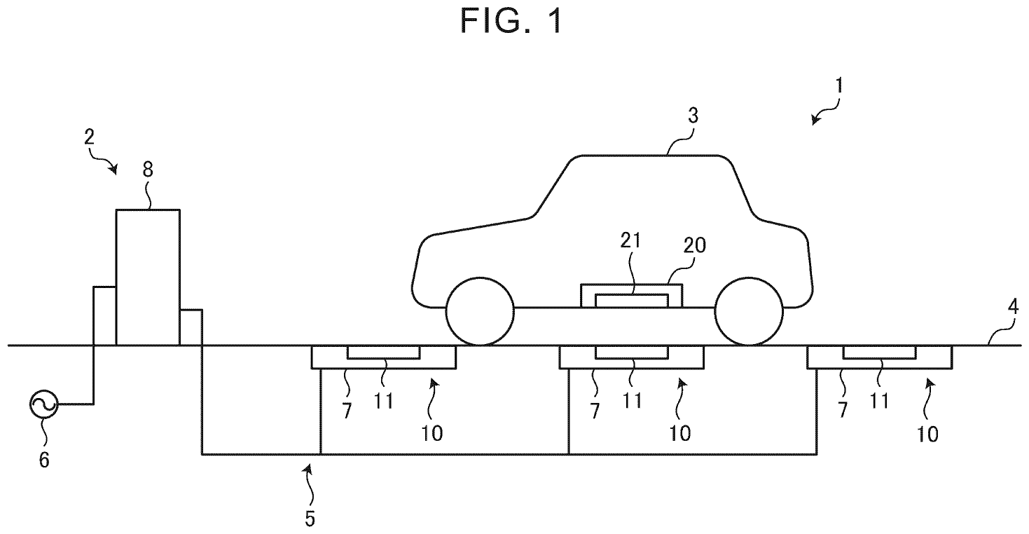

FIG. 1 is a schematic diagram illustrating a wireless power transfer system according to an embodiment. Wireless power transfer system 1 comprises a supply facility 2 and a vehicle 3. The supply facility 2 is a facility that supplies electric power to the traveling vehicle 3 in a non-contact manner. The vehicle 3 is an electrified vehicle capable of charging electric power supplied from an external power source, such as battery electric vehicle (BEV) and plug-in hybrid electric vehicle (PHEV).

The wireless power transfer system 1 performs wireless power transmission from the supply facility 2 to the vehicle 3 by magnetic field resonance coupling (magnetic field resonance). The wireless power transfer system 1 transmits power from the supply facility 2 to the vehicle 3 traveling on the road 4 in a contactless manner. That is, the wireless power transfer system 1 transmits power by a magnetic field resonance method, and realizes power supply during traveling to the vehicle 3 by using magnetic field resonance coupling (magnetic field resonance). The wireless power transfer system 1 can be represented as a dynamic wireless power transfer (D-WPT) system or a magnetic field dynamic wireless power transfer (MF-D-WPT) system.

The supply facility 2 includes a supply device 5 and an AC power supply 6 that supplies power to the supply device 5. The supply device 5 transmits the electric power supplied from the AC power supply 6 to the vehicle 3 in a non-contact manner. The AC power supply 6 is, for example, a commercial power supply. The supply device 5 comprises a power transmission device 10 having a primary coil 11.

The supply device 5 comprises a segment 7 comprising a primary coil 11 and a management device 8 for managing the segment 7. The segment 7 is embedded in the lane of the road 4. The management device 8 is installed beside the road 4. The segment 7 is electrically connected to the management device 8. The management device 8 is electrically connected to the AC power supply 6, and supplies the power of the AC power supply 6 to the segment 7. The segment 7 is electrically connected to the AC power supply 6 via the management device 8. A plurality of segments 7 can be arranged along the lane of the road 4.

For example, as shown in FIG. 1, the supply device 5 includes three segments 7 arranged side by side along a lane in the road 4, and one management device 8 to which three segments 7 are connected. The segment 7 has a function of transmitting electric power from the supply device 5 to the vehicle 3 in a non-contact manner. The management device 8 has a function of controlling wireless power transfer in the segment 7.

The vehicle 3 includes a power receiving device 20 having a secondary coil 21. The power receiving device 20 is provided at the bottom of the vehicle body of the vehicle 3. When the vehicle 3 travels on the road 4 on which the primary coil 11 is installed, the primary coil 11 on the ground side and the secondary coil 21 on the vehicle side face each other in the up-down direction. In the wireless power transfer system 1, power is transmitted from the primary coil 11 of the power transmission device 10 to the secondary coil 21 of the 25 power receiving device 20 in a non-contact manner while the vehicle 3 is traveling on the road 4.

In this description, the term “traveling” means a state in which the vehicle 3 is located on the road 4 for traveling. During traveling, a state in which the vehicle 3 is temporarily stopped on the road 4 is also included. For example, a state in which the vehicle 3 is stopped on the road 4 due to waiting for a signal or the like is also included in the traveling. On the other hand, even in a state where the vehicle 3 is located on the road 4, for example, when the vehicle 3 is parked and stopped, the vehicle is not included during traveling.

Further, in this explanation, a lane in which the primary coil 11 (segment 7) is embedded is referred to as a D-WPT lane, and a portion of the road 4 where wireless power can be transmitted by the supply device 5 is referred to as a D-WPT charge site in some cases. In D-WPT lane and D-WPT charge site, a plurality of primary coils 11 (a plurality of segments 7) are arranged side by side in the traveling direction of the vehicle 3 over a predetermined section of the road 4.

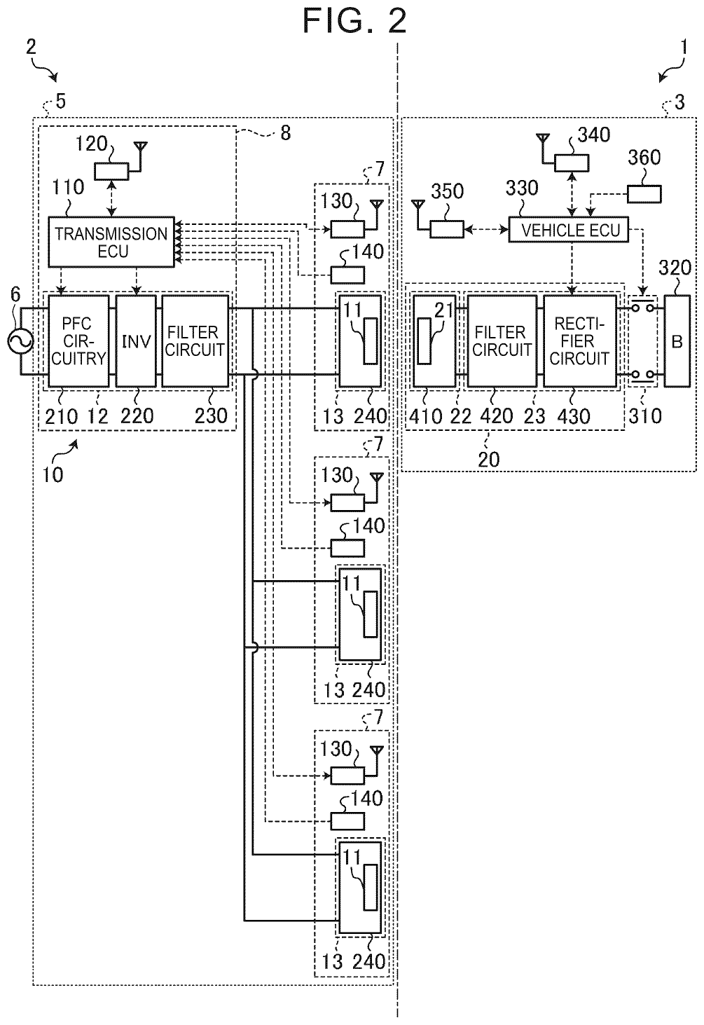

FIG. 2 is a diagram illustrating a configuration of a wireless power transfer system. In the supply facility 2, the supply device 5 and the AC power supply 6 are electrically connected to each other. In the supply device 5, the segment 7 and the management device 8 are electrically connected.

The supply device 5 includes a configuration provided in the management device 8 and a configuration provided in the segment 7. The supply device 5 includes a power transmission device 10, a power transmission electronic control unit (a power transmission ECU) 110, a first communication device 120, a second communication device 130, and a foreign object detection device 140.

The power transmission device 10 includes an electric circuit connected to the AC power supply 6. The power transmission device 10 includes a power factor collection circuit (PFC circuit) 210, an inverter (INV) 220, a filter circuit 230, and a power transmission side resonance circuit 240.

PFC circuitry 210 improves the power factor of the AC power inputted from the AC power supply 6, converts the AC power into DC power, and outputs the DC power to the inverter 220. PFC circuitry 210 includes AC/DC converters. PFC circuitry 210 is electrically connected to the AC power supply 6.

The inverter 220 converts the DC power inputted from PFC circuitry 210 into AC power. The switching elements of the inverter 220 are constituted by an insulated gate bipolar transistor (IGBT), a metal-oxide-semiconductor field effect transistor (MOSFET), or the like, and perform a switching operation in response to a control signal from a power transmission ECU 110. For example, the drive frequency of the inverter 220 is 85 kHz. The inverter 220 outputs the converted AC power to the filter circuit 230.

The filter circuit 230 removes noise included in the alternating current input from the inverter 220, and supplies the AC power from which the noise has been removed to the power transmission side resonance circuit 240. The filter circuit 230 is a LC filter that combines a coil and a capacitor. For example, the filter circuit 230 includes a T-type filter in which two coils and one capacitor are arranged in a T-shape. PFC circuitry 210, the inverter 220, and the filter circuit 230 constitute the power conversion unit 12 of the power transmission device 10.

The power transmission side resonance circuit 240 is a power transmission unit that transmits the AC power supplied from the filter circuit 230 to the power receiving device 20 in a non-contact manner. When AC power is supplied from the filter circuit 230 to the power transmission side resonance circuit 240, a current flows through the primary coil 11, and a magnetic field for power transmission is generated.

The power transmission side resonance circuit 240 includes a primary coil 11 and a resonance capacitor. The primary coil 11 is a power transmission coil. The resonance capacitor is connected in series to one end of the primary coil 11, and adjusts the resonance frequency of the power transmission side resonance circuit. The resonant frequency is 10 kHz to 100 GHz, preferably 85 kHz. For example, the power transmission device 10 is configured such that the resonance frequency of the power transmission side resonance circuit 240 matches the drive frequency of the inverter 220. The power transmission side resonance circuit 240 constitutes the primary device 13 of the power transmission device 10.

The power transmission device 10 includes a power conversion unit 12 and a primary device 13. The power conversion unit 12 includes a PFC circuit 210, an inverter 220, and a filter circuit 230. The primary device 13 includes a power transmission side resonance circuit 240. The power transmission device 10 has a configuration in which the power conversion unit 12 is provided in the management device 8 and the primary device 13 is provided in the segment 7.

In the supply device 5, the power conversion unit 12, the power transmission ECU 110, and the first communication device 120 of the power transmission device 10 are provided in the management device 8, and the primary device 13, the second communication device 130, and the foreign object detection device 140 of the power transmission device 10 are provided in the segments 7.

The power transmission ECU 110 is an electronic control device that controls the supply device 5. The power transmission ECU 110 includes a processor and a memory. The processor consists of central processing unit (CPU), digital signal processor (DSP), field-programmable gate array (FPGA), etc. The memory is a main storage device, and includes a random access memory (RAM), read only memory (ROM) and the like. The power transmission ECU 110 loads a program stored in the storage unit into a working area of a memory (main storage device) and executes the program, and controls the respective constituent units and the like through executing the program, thereby realizing a function that matches a predetermined objective. The storage unit includes an erasable programmable ROM (EPROM), hard disk drive (HDD) and a recording medium such as a removable medium. Examples of the removable medium include a disc recording medium such as universal serial bus memory (USB memory), compact disc (CD), digital versatile disc (DVD), Blu-ray (registered trademark) Disc (BD). The storage unit can store operating system (OS), various programs, various tables, various databases, and the like. Signals from various sensors are inputted to a power transmission ECU 110. A signal from the foreign object detection device 140 is inputted to the power transmission ECU 110. The power transmission ECU 110 performs various types of control based on signals inputted from various sensors.

For example, the power transmission ECU 110 performs power control for adjusting power for power transmission. In the power control, the power transmission ECU 110 controls the power transmission device 10. The power transmission ECU 110 outputs a control signal to the power conversion unit 12 to control the power supplied from the power conversion unit 12 to the primary device 13. The power transmission ECU 110 controls the switching elements included in PFC circuitry 210 to adjust the power for power transmission, and controls the switching elements included in the inverter 220 to adjust the power for power transmission.

Further, the power transmission ECU 110 executes communication control for controlling communication with the vehicle 3. In the communication control, the power transmission ECU 110 controls the first communication device 120 and the second communication device 130.

The first communication device 120 is a terrestrial communication device that performs wide area wireless communication. The first communication device 120 performs radio communication with the vehicle 3 of the vehicle 3 traveling on the road 4 prior to approaching D-WPT charge site. The condition prior to approaching D-WPT charge website means that the vehicle 3 is in a position where narrow-area radio communication with the supply device 5 cannot be performed.

Wide area wireless communication is communication with a communication distance of 10 meters to 10 kilometers. Wide-area wireless communication is communication having a longer communication distance than narrow-area wireless communication. As the wide-area wireless communication, various types of wireless communication having a long communication distance can be used. For example, communication compliant with a communication standard such as 3GPP (registered trademark) and 4G, LTE, 5G, WiMAX developed by IEEE is used for wide-area radio communication. In the wireless power transfer system 1, vehicle information associated with vehicle identification information (vehicle ID) is transmitted from the vehicle 3 to the supply device 5 using wide area wireless communication.

The second communication device 130 is a terrestrial communication device that performs narrow-area wireless communication. The second communication device 130 wirelessly communicates with the vehicle 3 approaching or entering D-WPT charge site among the vehicles 3 traveling on the road 4. The condition of approaching D-WPT charge site means that the vehicle 3 is in a position where narrow-area radio communication can be performed with the supply device 5.

Narrow-area wireless communication is communication with a communication distance of less than 10 meters. The narrow-area wireless communication is a communication having a shorter communication distance than the wide-area wireless communication. As the narrow-range wireless communication, various short-range wireless communication with a short communication distance can be used. For example, communication conforming to any communication standard established by IEEE, ISO, IEC or the like is used for narrow-area radio communication. As an example, Wi-Fi (registered trademark), Bluetooth (registered trademark) and ZigBee (registered trademark) are used for narrow area wireless communication. Alternatively, a radio frequency identification (RFID), dedicated short range communication (DSRC) or the like may be used as a technique for performing narrow-area radio communication. In the wireless power transfer system 1, vehicle identification information or the like is transmitted from the vehicle 3 to the supply device 5 by using narrow-area wireless communication.

The foreign object detection device 140 detects a metal foreign matter, a living body, or the like existing above the primary coil 11. The foreign object detection device 140 includes, for example, a sensor coil or an imaging device installed on the ground. The foreign object detection device 140 is for performing a foreign matter detection function (foreign object detection: FOD) and a biological protection function (living object protection: LOP) in the wireless power transfer system 1.

In the supply device 5, the configuration of the power transmission device 10 is divided into a segment 7 and a management device 8, and three segments 7 are connected to one management device 8. The power transmission device 10 is configured such that one inverter supplies power to the three power transmission side resonance circuits 240. Further, in the supply device 5, a signal from each segment 7 is input to the management device 8. Signals from the second communication device 130 and the foreign object detection device 140 provided in the first segment are inputted to the power transmission ECU 110. Similarly, signals from the second communication device 130 and the foreign object detection device 140 provided in the second segment are inputted to the power transmission ECU 110. Signals from the second communication device 130 and the foreign object detection device 140 provided in the third segment are inputted to the power transmission ECU 110. The power transmission ECU 110 can grasp the status of each segment 7 on the basis of the signals inputted from each segment 7.

The vehicle 3 includes a power receiving device 20, a charging relay 310, a battery 320, a vehicle ECU 330, a third communication device 340, a fourth communication device 350, and a global positioning system receiver (GPS receiver) 360.

The power receiving device 20 supplies the electric power received from the power transmission device 10 to the battery 320. The power receiving device 20 is electrically connected to the battery 320 via the charging relay 310. The power receiving device 20 includes a power receiving side resonance circuit 410, a filter circuit 420, and a rectifier circuit 430.

The power receiving side resonance circuit 410 is a power reception unit that receives power transmitted from the power transmission device 10 in a non-contact manner. The power receiving side resonance circuit 410 includes a power reception-side resonance circuit including a secondary coil 21 and a resonance capacitor. The secondary coil 21 is a power receiving coil that receives electric power transmitted from the primary coil 11 in a contactless manner. The resonance capacitor is connected in series to one end of the secondary coil 21, and adjusts the resonance frequency of the power receiving side resonance circuit 410. The resonance frequency of the power receiving side resonance circuit 410 is determined to coincide with the resonance frequency of the power transmission side resonance circuit 240.

The resonance frequency of the power receiving side resonance circuit 410 is the same as the resonance frequency of the power transmission side resonance circuit 240. Therefore, when a magnetic field is generated by the power transmission side resonance circuit 240 in a state where the power receiving side resonance circuit 410 faces the power transmission side resonance circuit 240, the vibration of the magnetic field is transmitted to the power receiving side resonance circuit 410. The primary coil 11 and the secondary coil 21 are in a resonant state. When an induced current flows through the secondary coil 21 by electromagnetic induction, an induced electromotive force is generated in the power receiving side resonance circuit 410. The power receiving side resonance circuit 410 receives the power transmitted from the power transmission side resonance circuit 240 in a contactless manner as described above. The power receiving side resonance circuit 410 supplies the power received from the power transmission side resonance circuit 240 to the filter circuit 420. The power receiving-side resonance circuit 410 constitutes the secondary device 22 of the power receiving device 20.

The filter circuit 420 removes noise included in the alternating current input from the power receiving side resonance circuit 410, and outputs the AC power from which the noise is removed to the rectifier circuit 430. The filter circuit 420 is a LC filter that combines a coil and a capacitor. For example, the filter circuit 420 includes a T-type filter in which two coils and one capacitor are arranged in a T-shape.

The rectifier circuit 430 converts the AC power input from the filter circuit 420 into DC power and outputs the DC power to the battery 320. The rectifier circuit 430 includes, for example, a full-bridge circuit in which four diodes are connected in a full-bridge manner as rectifier elements. A switching element is connected in parallel to each diode of the rectifier circuit 430. The respective switching elements of the rectifier circuit 430 are constituted by IGBT, and perform a switching operation in response to a control signal from the vehicle ECU 330. The rectifier circuit 430 supplies the converted DC power to the battery 320. The filter circuit 420 and the rectifier circuit 430 constitute the power conversion unit 23 of the power receiving device 20.

The power receiving device 20 includes a secondary device 22 and a power conversion unit 23. The secondary device 22 includes a power receiving side resonance circuit 410. The power conversion unit 23 includes a filter circuit 420 and a rectifier circuit 430.

The charging relay 310 is provided between the rectifier circuit 430 and the battery 320. The open/close status of the charging relay 310 is controlled by ECU 330 of vehicles. When the battery 320 is charged by the power transmission device 10, the charging relay 310 is controlled to be in a closed state. When the charging relay 310 is in the closed state, the rectifier circuit 430 and the battery 320 are electrically connected to each other. When the charging relay 310 is in the open state, the rectifier circuit 430 and the battery 320 are disconnected from each other. For example, when the charging relay 310 is in the open state, the vehicle 3 does not make a power supply request.

The battery 320 is a DC power source capable of being charged, and is constituted by, for example, a lithium ion battery, a nickel metal hydride battery, or the like. The battery 320 stores electric power supplied from the power transmission device 10 to the power receiving device 20. Further, the battery 320 can supply electric power to the driving motor of the vehicle 3. The battery 320 is electrically connected to a driving motor via a power control unit (PCU). PCU is a power converter that converts the DC power of the battery 320 into AC power and supplies the AC power to the traveling motor. The switching elements of PCU are constituted by IGBT and perform switching operations in response to control signals from ECU 330 of vehicles.

The vehicle ECU 330 is an electronic control device that controls the vehicle 3. The vehicle ECU 330 is configured in the same manner as the power transmission ECU 110 as the hardware configuration. Signals from various sensors mounted on the vehicle 3 are inputted to the vehicle ECU 330. In addition, the positioning signal received by GPS receiver 360 is inputted to the vehicle ECU 330. The vehicle ECU 330 may obtain the present position of the vehicle 3 from GPS receiver 360. The vehicle ECU 330 performs various controls based on the signals inputted from the various sensors.

For example, the vehicle ECU 330 performs contactless charge control in which electric power is transmitted from the primary coil 11 to the secondary coil 21 in a contactless manner, and the electric power received by the secondary coil 21 is stored in the battery 320. In the contactless charging control, the vehicle ECU 330 controls the rectifier circuit 430, the charging relay 310, the third communication device 340, and the fourth communication device 350. The contactless charging control includes power control for controlling charging power and communication control for controlling communication with the supply device 5. In the power control, the vehicle ECU 330 controls the switching elements included in the rectifier circuit 430 to adjust the electric power (charging electric power) supplied from the power receiving device 20 to the battery 320. In the communication control, the vehicle ECU 330 controls the third communication device 340 and the fourth communication device 350.

The third communication device 340 is a communication device on the vehicle side that performs wide area wireless communication. The third communication device 340 performs radio communication with the first communication device 120 of the supply device 5 in a condition in which the vehicle 3 traveling on the road 4 is not approaching D-WPT charge site. Wide-area wireless communication is bidirectional wireless communication. Communication between the first communication device 120 and the third communication device 340 is performed by high-speed wireless communication.

The fourth communication device 350 is a communication device on the vehicle side that performs narrow-area wireless communication. The fourth communication device 350 performs radio communication with the second communication device 130 of the supply device 5 while the vehicle 3 is approaching or entering D-WPT charge site. Narrow-area wireless communication is unidirectional wireless signaling. Uni-directional radio signaling is point to point signaling (P2PS). P2PS is used to notify the vehicle identity from the vehicle 3 to the supply device 5 in the respective activities of pairing, alignment check, magnetic coupling check, power transfer execution, and power transfer termination. P2PS can also be used as an alignment check for lateral alignment checking. The lateral direction is a width direction of the lane, and is a width direction of the vehicle 3.

GPS receiver 360 detects the present position of the vehicle 3 based on the positioning data obtained from the plurality of positioning satellites. The present position of the vehicle 3 detected by GPS receiver 360 is transmitted to the vehicle ECU 330.

Note that the supply device 5 may include the filter circuit 230 in the management device 8 instead of the segment 7. That is, the filter circuit 230 may be installed beside the road 4. The power conversion unit 12 includes a PFC circuit 210, an inverter 220, and a filter circuit 230, and the primary device 13 includes a power transmission side resonance circuit 240.

Further, the filter circuit 230 may be provided individually for the primary coils 11 or may be provided collectively for the plurality of primary coils 11.

The filter circuit 230 is not limited to a T-type filter, and may be, for example, a band-pass filter in which a coil and a capacitor are connected in series. The same applies to the filter circuit 420 of the vehicle 3.

Further, in the power transmission device 10, a changeover switch that switches the primary coil 11 to be energized when the inverter 220 is connected to the plurality of primary coils 11 may be provided in each of the primary devices 13. The changeover switch may be provided in the management device 8 beside the road 4 or may be provided in the vicinity of the primary coil 11.

Further, the power transmission side resonance circuit 240 is not limited to a configuration in which the primary coil 11 and the resonance capacitor are connected in series. The primary coil 11 and the resonance capacitor may be connected in parallel or may be a combination of parallel and series. In short, the power transmission side resonance circuit 240 only needs to be configured such that the resonance frequency of the power transmission side resonance circuit 240 coincides with the drive frequency of the inverter 220, and the connection relationship of the constituent elements is not particularly limited. The same applies to the power-receiving-side resonance circuit 410 of the vehicle 3.

The drive frequency of the inverter 220 is not limited to 85 kHz, and may be a frequency in the vicinity of 85 kHz. In short, the drive frequency of the inverter 220 may be a predetermined frequency band including 85 kHz.

In addition, the power transmission device 10 may have a configuration in which a plurality of inverters 220 is connected to an output-side power line (DC power line) of PFC circuitry 210.

Further, the foreign object detection device 140 may be provided not only on the ground side but also on the vehicle 3 side. For example, when the foreign object detection device on the vehicle 3 side detects a foreign matter, a living body, or the like existing above the primary coil 11, the power supply request can be stopped until the vehicle 3 passes through the primary coil 11.

Further, in the wireless power transfer system 1, the information transmitted from the vehicle 3 to the supply device 5 using the narrow-area wireless communication includes a power supply request, a power supply power request value, and the like in addition to the vehicle identification information. The power supply request is information indicating that the power transmission from the primary coil 11 is requested. The supply power request value is a request value of the amount of electric power transmitted from the supply device 5 to the vehicle 3. The vehicle ECU 330 can calculate the power supply demand based on SOC of the battery 320.

In addition, the wireless power transfer system 1 is not limited to a method of supplying power from the ground to the vehicle 3, and can also realize a method of supplying power from the vehicle 3 to the ground. In this case, the rectifier circuit 430 can be replaced with an inverter to realize power supply and rectification at the time of power reception.

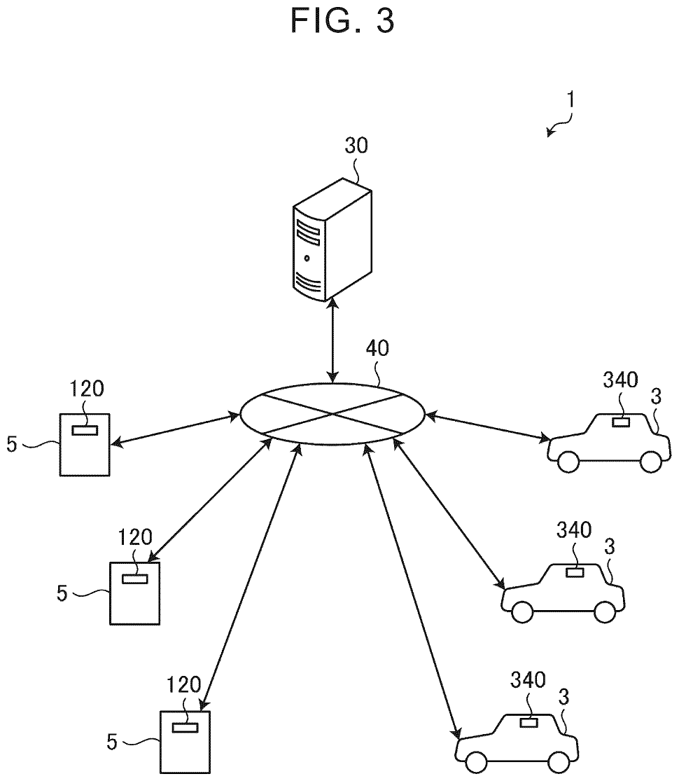

FIG. 3 is a schematic diagram for describing wide area radio communication in a wireless power transfer system.

In the wireless power transfer system 1, the vehicle 3 can communicate with the server 30, and the supply device 5 can communicate with the server 30. The server 30 is connected to the network 40 and is capable of communicating with the plurality of vehicles 3 and the plurality of supply devices 5 via the network 40. The network 40 includes a wide area network (WAN) that is a public communication network such as the Internet, a telephone communication network of a mobile telephone, and the like.

The vehicle 3 is connected to the network 40 by wide area wireless communication using the third communication device 340. The vehicle 3 transmits information to the server 30 and receives information from the server 30.

The supply device 5 is connected to the network 40 by wide area wireless communication using the first communication device 120. The supply device 5 transmits information to the server 30 and receives information from the server 30.

The server 30 processes information related to wireless power transfer between the vehicle 3 and the supply device 5. The server 30 includes a communication device and a control device. The control device has a hardware configuration similar to that of the power transmission ECU 110. The server 30 creates various lists related to wireless power transmission based on the information received from the vehicle 3 and the information received from the supply device 5. Then, the server 30 provides necessary information on wireless power transmission to the vehicle 3 and the supply device 5 at necessary timings based on various lists. In the wireless power transfer system 1, communication can be performed between the vehicle 3 and the supply device 5 via the server 30 by using wide-area wireless communication. The traveling vehicle 3 transmits vehicle identification information (vehicle ID) to the server 30, and the server 30 transmits vehicle information associated with the vehicle identification information to the supply device 5.

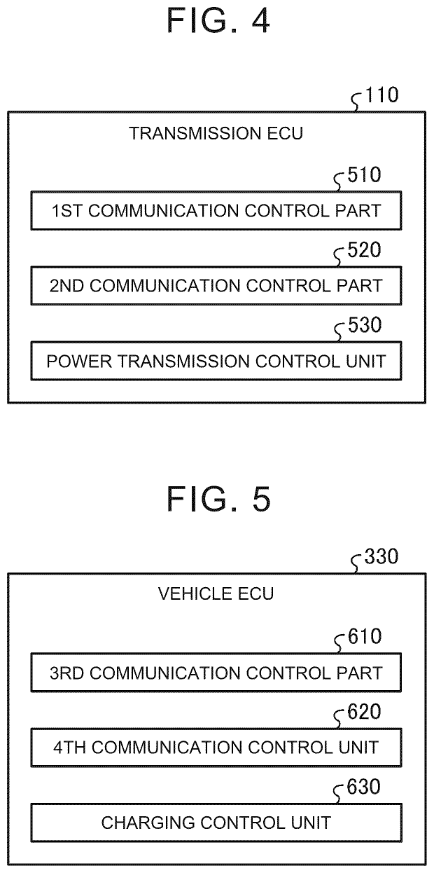

FIG. 4 is a diagram illustrating a functional of a power transmission ECU. The power transmission ECU 110 includes a first communication control unit 510, a second communication control unit 520, and a power transmission control unit 530.

The first communication control unit 510 executes first communication control for controlling the first communication device 120. The first communication control controls wide area wireless communication on the supply device 5 side, and controls communication of the supply device 5 using the first communication device 120. That is, the first communication control controls the communication of the management device 8 among the supply devices 5. The first communication control controls communication between the supply device 5 and the network 40, and controls communication between the supply device 5 and the server 30 via the network 40. The first communication control unit 510 is a supply equipment communication controller (SECC).

The second communication control unit 520 executes second communication control for controlling the second communication device 130. The second communication control controls the narrow-area wireless communication on the supply device 5 side, and controls the communication of the supply device 5 using the second communication device 130. That is, the second communication control controls the communication of the segment 7 of the supply device 5. The second communication control controls communication between the supply device 5 and the vehicle 3 as communication not through the network 40. The second communication control unit 520 is a primary device communication controller (PDCC).

The power transmission control unit 530 executes power transmission control for controlling the power transmission device 10. The power transmission control controls the power for power transmission, and controls the power conversion unit 12 of the power transmission device 10. The power transmission control unit 530 executes power control for controlling PFC circuitry 210 and the inverter 220.

FIG. 5 is a diagram illustrating a functional of a vehicle ECU. The vehicle ECU 330 includes a third communication control unit 610, a fourth communication control unit 620, and a charging control unit 630.

The third communication control unit 610 executes third communication control for controlling the third communication device 340. The third communication control controls wide area wireless communication on the vehicle 3 side, and controls communication of the vehicle 3 using the third communication device 340. The third communication control controls communication between the vehicle 3 and the network 40, and controls communication between the vehicle 3 and the server 30 via the network 40. The third communication control unit 610 is an EV communication controller (EVCC).

The fourth communication control unit 620 executes fourth communication control for controlling the fourth communication device 350. The fourth communication control controls the narrow-area wireless communication on the vehicle 3 side, and controls the communication of the vehicle 3 using the fourth communication device 350. The fourth communication control controls communication between the vehicle 3 and the supply device 5 as communication not through the network 40. The fourth communication control unit 620 is a secondary device communication controller (SDCC).

The charging control unit 630 executes charging control for controlling the power receiving device 20 and the charging relay 310. The charging control includes power control for controlling the received power in the secondary device 22 and relay control for controlling the connection state between the secondary device 22 and the battery 320. The charging control unit 630 executes power control for controlling the rectifier circuit 430. The charging control unit 630 executes relay control for switching the open/close state of the charging relay 310.

In the wireless power transfer system 1 configured as described above, wireless power transmission from the supply device 5 to the vehicle 3 is performed in a state where wireless communication between the vehicle 3 and the supply device 5 is established. In a state in which the vehicle 3 and the supply device 5 are paired by wireless communication, electric power is transmitted from the primary coil 11 on the ground side to the secondary coil 21 on the vehicle side in a non-contact manner. In the vehicle 3, charge control is performed to supply the electric power received by the secondary coil 21 to the battery 320.

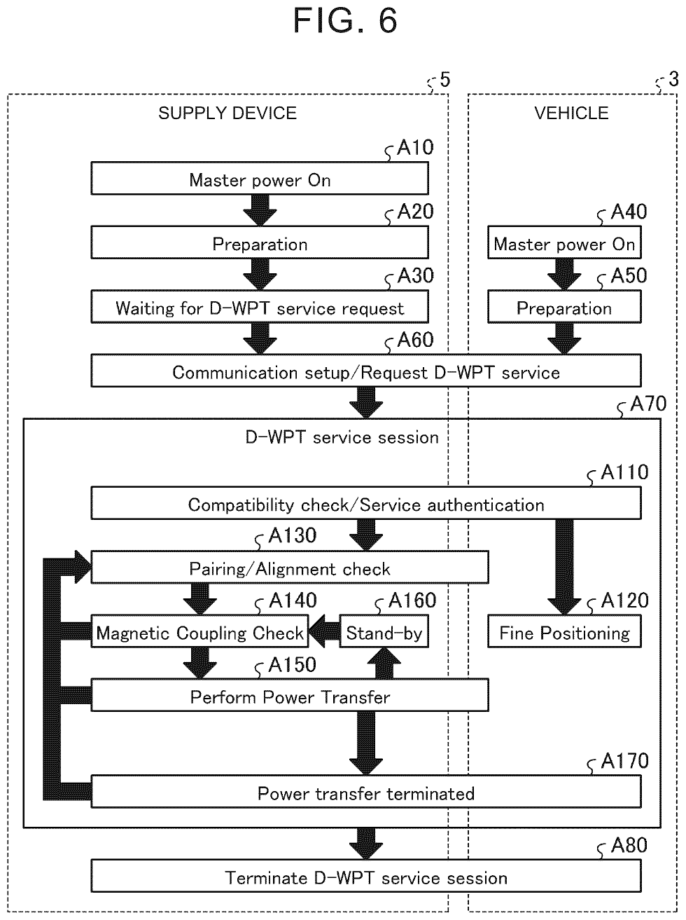

Next, referring to FIG. 6, a power transfer process (D-WPT process) will be described. A power transfer process is a process that is structured as a chain of activities and is derived from states and corresponding transitions.

FIG. 6 is a diagram for explaining a power transfer process. In FIG. 6, basic activities for explaining the power transfer process are shown. The thick arrows shown in FIG. 6 represent transitional lines. The state of the wireless power transfer system 1 in the power transfer process is represented by activities constituting the power transfer process.

The activity constituting the power transfer process includes a power transfer service session (D-WPT service session A70), which is an activity of performing power transfer, an activity of a stage prior to performing power transfer, and an activity of a stage after performing power transfer. The activity can be described separately according to the presence or absence of communication between the supply device 5 and the vehicle 3. The activity is divided into a state representing the state of only the supply device 5 side without communication, a state representing only the vehicle 3 side without communication, and a state representing both the supply device 5 with communication and the vehicle 3.

As shown in FIG. 6, the activity includes the master power on state (Master power On) A10, preparation (Preparation) A20, waiting for a request from the vehicle 3 (Waiting for D-WPT service request) A30, the master power on state (Master power On) A40, preparation (Preparation) A50, communication setting (Communication setup) and a D-WPT service request (Request D-WPT service) A60, a D-WPT service session (D-WPT service session) A70, and an end of D-WPT service session (Terminate D-WPT service session) A80.

The preparation A20 is the preparation of the supply device 5. In the preparation A20, the supply device 5 performs the activation and safety check of the circuitry without communicating with the vehicle 3. The supply device 5 transitions to the preparation A20 state when the master power is in the on-state A10. When the supply device 5 starts up the circuit in the preparation A20 and confirms the safety, the state transitions to waiting for the request from the vehicle 3 (Waiting for D-WPT service request) A30. On the other hand, when there is a problem with the supply device 5, the supply device 5 notifies the vehicle 3 of information (unavailability notification) indicating that the wireless power transfer system 1 is unavailable by wide area wireless communication. The first communication device 120 transmits an unavailability notification to the vehicle 3.

The preparation A50 is a preparation condition of the vehicle 3. In the preparation A50, the vehicle 3 carries out the activation and safety checks of the circuitry without communication with the supply device 5. Vehicle 3 transitions to the preparation A50 state when the master power is in the on-state A40. Then, when the vehicle 3 is able to confirm the safety by activating the circuit in the preparation A50, the state transitions to the communication setting (Communication setup) and the request for D-WPT service (Request D-WPT service) A60. On the other hand, when the vehicle 3 is problematic, the vehicle 3 does not initiate wide area radio communication and does not perform subsequent sequencing in D-WPT process.

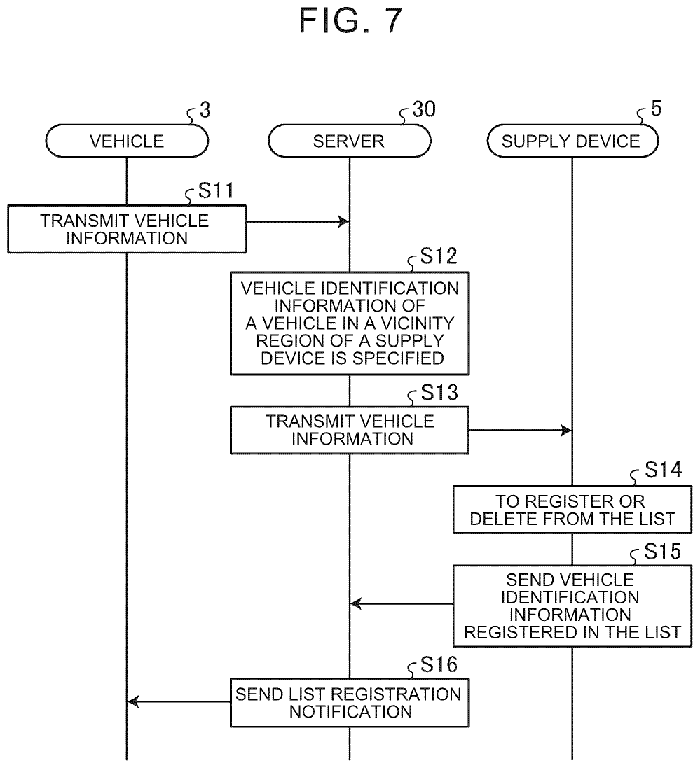

The communication setup and request D-WPT service A60 is initiated by the vehicle ECU 330. In the communication configuration and request D-WPT service A60, the vehicle ECU 330 initiates wide area radio communication. First, the third communication device 340 transmits a request signal of D-WPT service when the vehicle 3 transitions from the preparation A50 to the communication setting and the request D-WPT service A60. The third communication device 340 wirelessly communicates with the first communication device 120 corresponding to D-WPT charge site on which the vehicle 3 is scheduled to enter or has entered. The communication target first communication device 120 is selected based on a positional relation between the present position of the vehicle 3 and the position of D-WPT charge site. When the first communication device 120 receives the request signal of D-WPT service in the state of the request waiting A30 from the vehicle 3, the state transits to the communication setting and the request D-WPT service A60 in the supply device 5. Various kinds of information of wide area radio communication and P2PS communication are linked by using vehicle-identification information. This communication setting and request D-WPT service A60 are processed in of FIG. 7.

FIG. 7 is a diagram illustrating a case in which communication using wide area radio communication is performed between vehicles and a supply device. The vehicle 3 transmits the vehicle data to the server 30 (S11). In S11, the third communication device 340 of the vehicle 3 transmits the vehicle data to the server 30. The vehicle information includes vehicle identification information, various parameters of the power receiving device 20, current position information of the vehicle 3, and required power. The vehicle ECU 330 calculates the required power based on SOC (State of Charge) of the battery 320. In S11, the vehicle ECU 330 transmits the vehicle data from the third communication device 340 at predetermined intervals. The predetermined period of time is set according to the distance from the present position of the vehicle 3 to the start point of D-WPT charge site. The shorter the distance from the vehicle 3 to the start point of D-WPT charge site, the shorter the interval between the predetermined times.

Upon receiving the vehicle information from the vehicle 3, the server 30 identifies the vehicle identification information of the vehicle 3 located in the vicinity area of the supply device 5 based on the present position information of the vehicle 3 included in the vehicle information (S12). In S12, the server 30 identifies the vehicle 3 located in the predetermined neighborhood area from the supply device 5 based on the present position information of the vehicle 3 and the position information of the supply device 5. The neighboring region is set to, for example, a region within 500 meters.

When the vehicle identification information of the vehicle 3 is identified, the server 30 transmits the vehicle information to the supply device 5 (S13). In S13, the transmitting device of the server 30 transmits the vehicle-information to the supply device 5.

Upon receiving the vehicle information from the server 30, the supply device 5 registers and deletes the vehicle identification information in the identification information list (S14). In S14, the power transmission ECU 110 registers and deletes the vehicle identification information in the identification information list so that the vehicle identification information associated with the vehicle information is registered in the identification information list without excess or deficiency.

When the vehicle identification information is registered and deleted in the identification information list, the supply device 5 transmits the vehicle identification information registered in the identification information list to the server 30 (S15). In S15, the first communication device 120 of the supply device 5 transmits the vehicle-identification information to the server 30.

When receiving the vehicle identification information from the supply device 5, the server 30 transmits a list registration notification to the vehicle 3 corresponding to the vehicle identification information registered in the identification information list (S16). In S16, the communication device of the server 30 transmits a list-registration notification to the vehicle 3. The list registration notification is a notification indicating that the vehicle identification information is registered in the identification information list, and includes identification information of the supply device 5 and position information of the supply device 5.

In this way, when the vehicle 3 starts wide area wireless communication and the supply device 5 and the vehicle 3 are both in the communication setting and the request D-WPT service A60, the communication setting by the wide area wireless communication succeeds. When the communication setting is successful, the status transits to D-WPT service session (D-WPT service session) A70.

Return to FIG. 6. D-WPT service session A70 transmits power from the power transmission side resonance circuit 240 of the supply device 5 to the power receiving side resonance circuit 410 of the vehicle 3 in a non-contact manner while a communication connection is established between the supply device 5 and the vehicle 3. D-WPT service-session A70 begins with successful communication setup and ends upon termination of communication. In D-WPT service session A70 state, when the communication ends, the state transitions to end D-WPT service session (Terminate D-WPT service session) A80.

In the terminate D-WPT service session A80, the vehicle 3 terminates the wide area radio communication with the supply device 5. The vehicle 3 and the supply device 5 may receive a trigger to terminate D-WPT service-session A70. Then, the vehicle ECU 330 prevents D-WPT from being started for the secondary device 22 and the vehicle 3 until the third communication device 340 receives the subsequent notification (request of D-WPT service).

Detailed activities of D-WPT service session A70 will now be described. D-WPT service session A70 includes compatibility check (Compatibility check) and service authentication (Service authentication) A110, detailed alignment check (Fine Positioning) A120, pairing (Pairing) and alignment check (Alignment check) A130, magnetic coupling check (Magnetic Coupling Check) A140, performance of power transfer (Perform Power Transfer) A150, standby (Stand-by) A160, and termination of power transfer (Power transfer terminated) A170.

A compatibility check and service authentication A110 will be described. After the communication setup is successful, the vehicle ECU 330 and the power transmission ECU 110 confirm that the primary device 13 and the secondary device 22 are compatible. The compatibility check is performed on the supply device 5 side on the basis of information associated with the vehicle identification information acquired by communication. Examples of the check items include the lowest ground height of the secondary device 22, the shape type of the power receiving side resonance circuit 410, the circuit topology of the secondary device 22, the self-resonance frequency of the secondary device 22, and the number of the secondary coils 21.

In the compatibility checking and service authentication A110, first, the vehicle 3 transmits compatibility data (Compatibility Information) of the power receiving device 20 from the third communication device 340 to the supply device 5. The compatibility information of the power receiving device 20 is transmitted by wide area wireless communication. The first communication device 120 of the supply device 5 receives the compatibility information of the power receiving device 20 from the vehicle 3. Then, the first communication device 120 of the supply device 5 transmits the compatibility information of the power transmission device 10 to the vehicle 3. The compatibility information of the power transmission device 10 is transmitted by wide area wireless communication. The third communication device 340 of the vehicle 3 receives the compatibility information of the power transmission device 10 from the supply device 5. The compatibility information can be transmitted and received between the vehicle 3 and the supply device 5 by wide area wireless communication via the network 40 and the server 30.

Elements of the compatibility information transmitted by the vehicle 3 to the supply device 5 include vehicle identification information, WPT power class (WPT Power Classes), gap class (Air Gap Class), WPT drive frequency (WPT Operating Frequencies), WPT frequency adjustment, WPT type (WPT Type), WPT circuit topology (WPT Circuit Topology), detailed alignment method (Fine Positioning Method), pairing method (Pairing Method), alignment method (Alignment Method), power adjustment function presence/absence information, and the like.

Elements of the compatibility information the supply device 5 transmits to the vehicle 3 include: supply device identification information, WPT power classes, WPT drive frequencies, WPT frequency adjustment, WPT types, WPT circuitry topologies, detailed alignment methods, pairing methods, alignment methods, presence or absence of power adjustment functions, and the like.

Each element name will be described in detail. Note that each element of the compatibility information transmitted from the vehicle 3 to the supply device 5 will be described, and a description of the compatibility information that overlaps with the compatibility information transmitted from the vehicle 3 to the supply device 5 among the compatibility information transmitted from the supply device 5 to the vehicle 3 will be omitted.

The gap class is information indicating a gap class that can be received by the secondary device 22. WPT power class indicates a power class that can be received by the secondary device 22. WPT drive frequency indicates the frequency of the received power received by the secondary device 22. WPT frequency adjustment is information indicating whether or not the drive frequency can be adjusted. WPT type is information indicating the shape type of the power receiving side resonance circuit 410, and indicates the coil shape of the secondary coil 21. Examples of WTP types include circles and solenoids. WPT circuit topology is an example of a configuration in which the secondary coil 21 is connected to the resonant capacitor. WTP topologies include series and parallel. The detailed alignment method is information indicating how to perform the alignment when performing the alignment. The pairing method is a method in which the vehicle 3 performs pairing for identifying the supply device 5. The alignment method indicates a method of checking the relative position of the secondary device 22 and the primary device 13 before the start of power transmission.

A fine positioning A120 will be described. The vehicle 3 performs fine positioning A120 prior to or in parallel with the pairing and alignment check A130. When the vehicle ECU 330 determines that the vehicle 3 has approached or entered an area where the supply device 5 is installed (D-WPT charge site), it starts fine positioning A120.

The vehicle ECU 330 guides the vehicle 3 to align the primary device 13 with the secondary device 22 within the limits of establishing adequate magnetic coupling for wireless power transfer.

The fine positioning A120 is basically performed manually or automatically on the vehicle-3 side. The fine positioning A120 can cooperate with an automated driving assistance (ADAS).

The activities of the fine positioning A120 may then continue until the vehicle 3 leaves D-WPT charge site or the state changes to communication termination, and may be performed based on the registration data transmitted from the supply device 5 to the vehicle 3 by the wide area radio communication. This communication termination is the terminate D-WPT service session A80.

Pairing and alignment checking (Pairing/Alignment check) A130 will be described. Here, pairing (Pairing) and alignment checking (Alignment check) are separately described.

Pairing will be described. P2PS interface performing the narrow-area radio communication ensures that the primary device 13 and the secondary device 22 are uniquely paired. The pairing state process is as follows:

First, the vehicle ECU 330 recognizes that the vehicle 3 has approached or entered D-WPT charge website. For example, the vehicle ECU 330 has map information including D-WPT charge site, and recognizes the approach or approach by the straight line distance or the like as compared with the position information of the host vehicle obtained by GPS receiver 360. The vehicle 3 transmits to server 30 by wide area radio communication to which D-WPT charge site it has approached. In short, the third communication device 340 notifies the cloud of an indication that the vehicle 3 is approaching any of D-WPT charge sites. Further, when the vehicle ECU 330 recognizes that the vehicle 3 is approaching or entering D-WPT charge site, the fourth communication device 350 starts transmitting the modulated signal at regular intervals for pairing the primary device 13 and the secondary device 22.

In addition, the supply device 5 may recognize that the vehicle 3 has approached or entered the D-WPT charge site by using the information acquired from the server 30 by the wide area radio communication. The server 30 allocates the vehicle identities of the vehicles 3 approaching at the respective D-WPT charge sites to the supply devices 5 corresponding to the lanes. Since the supply device 5 only needs to refer to the vehicle identification information whose number is narrowed by the server 30, the authentication process can be performed in a short time. When the supply device 5 recognizes that the vehicle 3 is approaching D-WPT charge site, the second communication device 130 enters the standby mode. In the standby mode, the reception of the modulated signal from the fourth communication device 350 of the vehicle 3 is awaited. The modulated signal includes vehicle identification information.

When the second communication device 130 receives the modulated signal from the vehicle 3, the supply device 5 compares the vehicle identification information received by the narrow-area wireless communication with the vehicle identification information in the identification information list obtained by the wide-area wireless communication with the plurality of vehicles 3 coming toward D-WPT charge site. By this comparison, the supply device 5 identifies the vehicle 3.

When the vehicle ECU 330 recognizes that the vehicle 3 is outside D-WPT charge site, it stops transmitting the modulated signal from the fourth communication device 350. The vehicle ECU 330 can determine whether or not the vehicle has passed D-WPT charge website based on the map information and the position information of the host vehicle.

When determining that the vehicle 3 is not traveling in D-WPT lane or that the vehicle 3 is not approaching D-WPT charge site, the supply device 5 stops the standby of the modulated signal from the fourth communication device 350.

Pairing is performed on the primary device 13 until the vehicle 3 exits D-WPT charge site or the status changes to communication termination. When pairing (Pairing) is complete, the status transitions to alignment checking (Alignment check).

The alignment check will be described. The alignment check is intended to ensure that the lateral distance between the primary device 13 and the secondary device 22 is within an acceptable range. Alignment checking is performed using narrow-area radio communication (P2PS).

Alignment checking is performed continuously based on P2PS until the vehicle 3 leaves D-WPT charge site or the status changes to communication termination. The result of the alignment check may be transmitted from the first communication device 120 to the third communication device 340 by wide area wireless communication.

A magnetic coupling check A140 will be described. In the magnetic coupling check A140, the supply device 5 checks the magnetic coupling condition and confirms that the secondary device 22 is within the allowable range. When the magnetic coupling check A140 ends, the status transitions to A150 of performing the power transfer.

A A150 of performing the power transmission will be described. In this state, the supply device 5 transmits power to the power receiving device 20. The power transmission device 10 and the power receiving device 20 need to be provided with the capability to control the transmission power (transmission power and reception power) in order to protect the power receiving device 20 and the battery 320 and the usefulness of MF-D-WPT. Larger power transfer helps to increase the travel distance of the power receiving device 20 without static wireless charging and conductive charging. However, the capacity of the battery 320 varies depending on the vehicle type of the vehicle 3, and the demand for driving power may rapidly fluctuate. The sudden fluctuation includes a sudden regenerative brake. Since the regenerative braking is prioritized when the regenerative braking is performed while D-WPT charger is traveling, the power received from the power receiving device 20 is supplied to the battery 320 in addition to the regenerative power. In this case, in order to protect the battery 320 from overcharge, adjustment of the transmission power by the power receiving device 20 is required.

Despite the need for power control, no new communication is initiated between the supply device 5 and the power receiving device 20 in this state. This is because communication can compromise response and accuracy in power control due to its instability and latency. Therefore, the supply device 5 and the power receiving device 20 perform power transmission and control thereof based on known information up to this state.

The supply device 5 increases the transmission power of the magnetic coupling check with respect to the power request transmitted from the third communication device 340 by using the wide area wireless communication in advance. The supply device 5 keeps the current and voltage variations within its range and attempts to maximize the power transmitted during the transition.

The power receiving device 20 basically receives the transmitted power from the power transmission device 10 without any control. However, the power receiving device 20 starts the control when the transmission power exceeds or is exceeding the limit, such as the rated power of the battery 320 that varies according to the charging state or the driving power demand of the vehicle 3. Power control in the vehicle ECU 330 is also required to cope with malfunctions in wide-area radio communication. This malfunction leads to a conflict between the power control target in the primary device 13 and the request from the third communication device 340, and a sudden failure of the power receiving device 20 and the battery 320 during the power transmission. The power receiving device 20 controls the power transmitted under the power request rate notified by the first communication device 120.

The power requirements are determined based on compatibility-checking information such as WPT topology, geometry, ground clearance, EMC of the vehicle 3 and the primary device 13. The magnetic field differs according to these specifications, and power needs to be transmitted to the extent that EMC is satisfied.

The power control in the power transmission ECU 110 and the power receiving device 20 may interfere with each other. In particular, there is a possibility of interference when the supply device 5 attempts to realize a power request that is larger than the latest power limit in the power receiving device 20 by wide area wireless communication. An example of this is rapid regeneration control with a relatively small battery 320 in the vehicle 3. If possible, it is desirable for the supply device 5 to be able to detect a mismatch between the power control target and the limit and to adjust the power transfer in order to eliminate the mismatch.

For example, when the power transmission is interrupted for a short period of time while the secondary device 22 is still on the primary device 13, such as when a foreign object on the primary device 13 is detected by the foreign object detection device 140 or when the coupling factor of the magnetic coupling becomes low due to the misalignment of the secondary device 22, the state transitions to standby (Stand-by) A160. When the foreign object detection device is provided in the vehicle 3, the foreign matter may be detected on the vehicle 3 side.

When the secondary device 22 passes over the primary device 13, the status transitions to the power transfer terminated A170. In this case, since the magnetic coupling between the two devices is weakened, the transmitted power is reduced. Since the supply device 5 can detect that the magnetic coupling is weakened by monitoring the transmission power, the supply device 5 basically determines the status transition to the power transfer terminated A170, and then starts to lower the voltage to stop the power transmission.

The standby A160 will be described. In this state, when the power transfer is interrupted for some reason for a short time and D-WPT is ready in both the vehicle 3 and the supply device 5, the state returns to A150 of performing the power transfer. If there is a possibility of interrupting the power transfer, the status is in the standby A160.

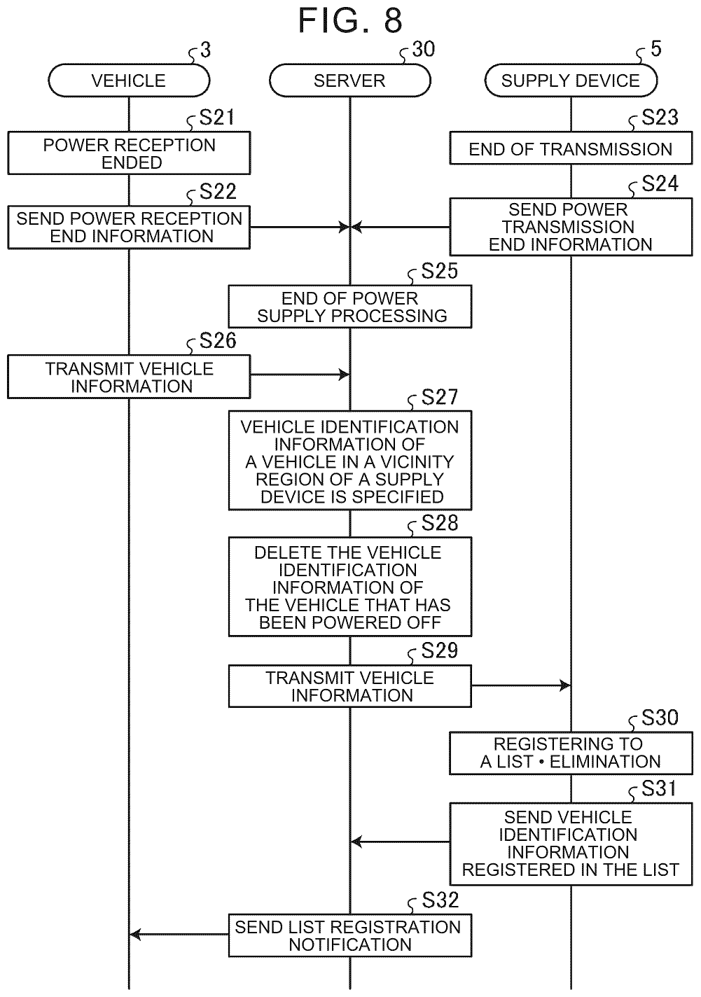

The power transfer terminated A170 will be described. In this state, the supply device 5 reduces the transmitted power to zero and holds or uploads power transmission result data such as total transmission power, power transmission efficiency, and fault history. Each data is tagged with vehicle identification information. Finally, the supply device 5 deletes the vehicle identity of the vehicle 3 that has passed D-WPT charge site. Thus, the supply device 5 can prepare for pairing and power transmission to other vehicles thereafter. FIG. 8 is a diagram showing a process sequence of the power transfer terminated A170.

FIG. 8 is a diagram illustrating an operation after the power supply during traveling from the supply device to the vehicles is completed. When the power receiving device 20 of the vehicle 3 terminates the power receiving from the supply device 5 (S21), the vehicle 3 transmits the power receiving termination data to the server 30 (S22). In S22, the power reception termination data is transmitted from the third communication device 340 of the vehicle 3. The power reception end information includes, for example, vehicle identification information of the vehicle 3, received power from the supply device 5, power reception efficiency, and an abnormality detection result as information regarding power reception from the supply device 5.

When S21 process is performed, the supply device 5 terminates the power transmission to the vehicle 3 (S23). The processing of S21 and the processing of S23 may or may not be performed simultaneously. When S23 process is performed, the supply device 5 transmits the power transmission termination data to the server 30 (S24). In S24, the power transmission termination data is transmitted from the first communication device 120 of the supply device 5.

Upon receiving the power reception end information from the vehicle 3 and receiving the power transmission end information from the supply device 5, the server 30 performs a power supply end process of ending the power supply from the supply device 5 to the vehicle 3 (S25). In the power supply end process, a process of calculating the amount of electric power supplied from the supply device 5 to the vehicle 3 and a process of charging the user of the vehicle 3 based on the calculated amount of electric power supplied are performed on the basis of the power reception end information and the power transmission end information.

In addition, the vehicle 3 transmits the vehicle data to the server 30 regardless of the power supply termination process (S26). In S26, the vehicle data is transmitted from the third communication device 340 of the vehicle 3.

When receiving the vehicle information from the vehicle 3 after the power supply termination process is performed, the server 30 identifies the vehicle identification information of the vehicle 3 located in the neighborhood area of the respective supply devices 5 based on the vehicle information (S27).

Then, when the power supply end process for a certain vehicle 3 has been performed in a certain supply device 5, the server 30 deletes the vehicle identification information of the vehicle 3 for which the power supply end process has been performed from the vehicle identification information of the vehicle 3 in the vicinity area of the supply device 5 specified by S27 process (S28).

Thereafter, the server 30 transmits, to the respective supply devices 5, the vehicle information associated with the vehicle identification information that has not been deleted in S28 process among the vehicle identification information of the vehicle 3 identified as being located in the neighborhood area of the respective supply devices 5 (S29).

After the vehicle information is transmitted to the respective supply devices 5 in S29 process, when the supply device 5 receives the vehicle information from the server 30, the supply device 5 registers and deletes the vehicle identification information in the identification information list (S30). S30 process is the same as S14 process of FIG. 7. After that, the supply device 5 transmits the vehicle identification information registered in the identification information list to the server 30 (S31). S31 process is the same as S15 process of FIG. 7.

When receiving the vehicle identification information from the supply device 5, the server 30 transmits a list registration notification to the vehicle 3 corresponding to the vehicle identification information registered in the identification information list (S32). S32 process is the same as S16 process of FIG. 7.

Consequently, when the process shown in of FIG. 8 is performed, the vehicle identification information is registered for the vehicle 3 that is located in the vicinity of the respective supply devices 5 in the identification information list and that the power supply from the supply device 5 has not been completed and that the vehicle identification information has not been requested to be deleted. When the vehicle identification information of the vehicle 3 is registered in the identification information list of any of the supply devices 5, the vehicle 3 receives the list registration notification. Therefore, the vehicle ECU 330 can determine that the host vehicle is registered in any of the supply devices 5 by receiving the list-registration notification. When the vehicle 3 goes out of the vicinity of the supply device 5, the vehicle identification information of the vehicle 3 is deleted from the identification information list of the supply device 5.

Returning to FIG. 6. In addition, in power transfer terminated A170, the power receiving device 20 does not need to do anything in order to eliminate the transmission power. P2PS interface is kept active when the vehicle 3 is in D-WPT lanes, and the status of the power receiving device 20 automatically transitions to pairing for power transfer from the next primary device 13. Like the transition line shown in FIG. 6, the status transitions from the power transfer terminated A170 to the pairing and alignment check A130. As shown in FIG. 6, since the predetermined transition condition is satisfied, the transition from the magnetic coupling check A140 to the pairing and alignment check A130 can be made, and the transition from A150 of executing the power transmission to the pairing and alignment check A130 can be made. The pairing may be performed individually for the plurality of primary coils 11, or may be performed by bundling the plurality of primary coils 11 at a representative point.

Then, when there is no D-WPT request from the vehicle ECU 330 or when a series of states from the communication setting and the request D-WPT service A60 to the power transfer terminated A170 is prohibited, D-WPT service session A70 transitions to the terminate D-WPT service session A80 and stops the wide area radio communication between the first communication device 120 and the third communication device 340. For example, D-WPT is stopped when the charge status in the battery 320 is too high or when the power receiving device 20 is too hot for continuous power transfer. Such unwanted D-WPT can be disabled by simply deactivating P2PS interface. However, by stopping the wide area wireless communication, the power transmission ECU 110 can release the memories occupied for the vehicle 3 without requiring D-WPT by terminating the established wide area wireless communication.

Further, D-WPT service session A70 is not limited to a transition such as a transition line shown in FIG. 6. In D-WPT service session A70, if the power transfer process remains in D-WPT service session A70 when the activities after the pairing and alignment check A130 are terminated, the process does not transition to the terminate D-WPT service session A80 but transitions to the compatibility check and service authentication A110. For example, if a predetermined transition condition is met in the state of the magnetic coupling check A140, the state may transition to a compatibility check and service authentication A110. The transitions of the activities in D-WPT service session A70 are controlled by a control device of the wireless power transfer system 1. A control device of the wireless power transfer system 1 includes a power transmission ECU 110 and a vehicle ECU 330. The power transmission ECU 110 includes a function as a control device of the supply device 5. The vehicle ECU 330 includes a function as a control device of the power receiving device 20.

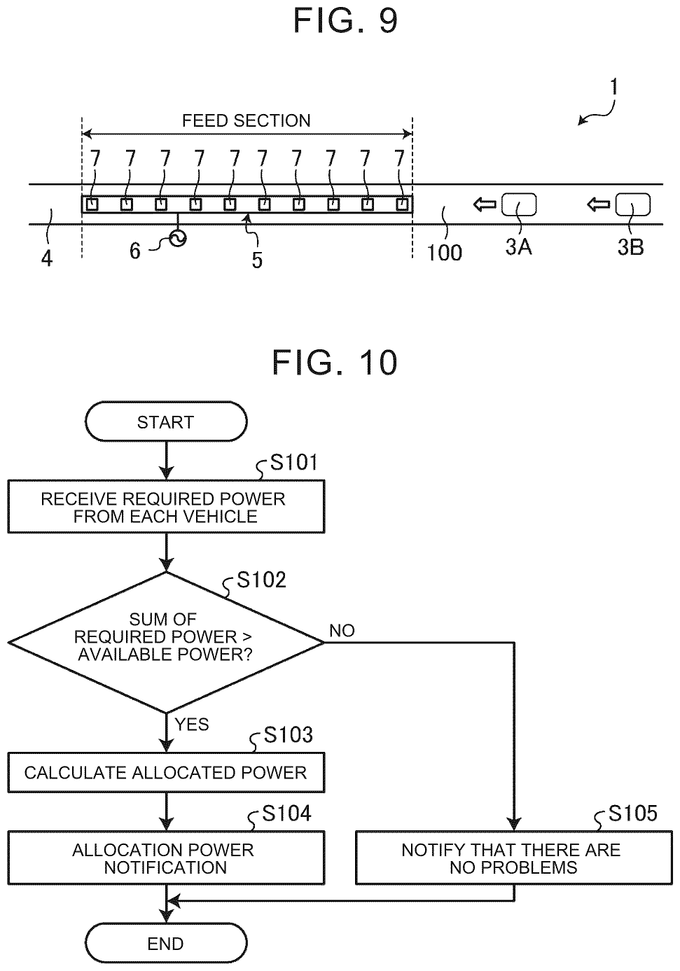

FIG. 9 is a diagram for describing radio communication performed between vehicles traveling on a power supply lane and a supply device on the ground. It should be noted that although the management device 8 including the power transmission ECU 110 includes a configuration installed beside the road 4, it is simplified in FIG. 9.

The power supply lane 100 is a lane in which the supply device 5 is provided over a predetermined section of the road 4. A section in which the supply device 5 is installed is a power supply section. The power supply section is a section in which a plurality of segments 7 are arranged side by side in the lane direction. Each segment 7 is provided with a primary coil 11. For example, by placing a plurality of segments 7 over a few hundred meters, the feed section is formed to a length of a few hundred meters. Note that D-WTP of the above-described lanes can be read as a power supply lane 100, and the above-described D-WPT charge-site can be read as a power supply section.

In the wireless power transfer system 1, a power supply section formed by one supply device 5 is one power supply section. One AC power supply 6 is electrically connected to one supply device 5. The power that can be supplied by the supply device 5 depends on the power of the AC power supply 6. In other words, there is a limit to the power that can be supplied by the supply device 5. Therefore, the supply device 5 adjusts the distribution of the supply power to the vehicle 3 traveling on the power supply lane 100.

As shown in FIG. 9, when a plurality of vehicles 3A, 3B are traveling on the power supply lane 100, required power is transmitted from the respective vehicles 3A, 3B to the supply device 5 using wide area radio communication. When receiving the required power from the vehicle 3 traveling on the power supply lane 100, the supply device 5 compares the required power of the respective vehicles 3A, 3B with the power that can be supplied by the supply device 5. The supply device 5 adjusts the distribution of the supplied power for each vehicle 3 based on the comparison result. The supply device 5 sets the distribution of the supply power based on the physique of the vehicle 3 and SOC of the battery 320. The supply device 5 can acquire vehicle data including the physique, SOC, and the like of the vehicle 3 by communication via the server 30, direct communication with the vehicle 3, and the like.

For example, when the physique of the preceding vehicle 3A is larger than the physique of the subsequent vehicle 3B, the supply device 5 adjusts the distribution of the electric power such that the supply electric power to the vehicle 3A is larger than the supply electric power to the vehicle 3B. Further, the supply device 5 adjusts the distribution of the power so that the supply power to the vehicle 3A is smaller than the supply power to the vehicle 3B when SOC of the vehicle 3A is larger than SOC of the vehicle 3B. The supply device 5 can comprehensively determine the condition of the vehicle 3 such as the physique and SOC of the vehicle 3 and adjust the distribution of the supply power to the vehicle 3. As an example, if the physique and SOC of the vehicle 3 are satisfied, the distribution of the supplied power can be set preferentially by SOC, and the distribution of the final supplied power can be adjusted by the distribution of the supplied power according to the physique. For a plurality of vehicles 3A, 3B, the respective conditions of the vehicle 3A and the vehicle 3B may be compared to adjust the distribution to the vehicle 3A and the distribution to the vehicle 3B.

FIG. 10 is a flow chart illustrating a control flow when the power supply lane is a single lane. The control shown in FIG. 10 is performed by the supply device 5. It should be noted that two vehicles 3A, 3B as shown in FIG. 9 travel on the power supply lane 100.

The supply device 5 receives the required electric power from the vehicles 3 traveling on the power supply lane 100 (S101). In S101, the required power transmitted from the vehicle 3 traveling several hundred meters ahead of the supply device 5 by using the wide area radio communication in the power supply lane 100 is received by the supply device 5. The supply device 5 receives the required power from the vehicle 3 which may enter its supply section. The vehicle 3 capable of transmitting the required power is a vehicle equipped with the power receiving device 20 including the secondary coil 21. In the embodiment shown in FIG. 9, the supply device 5 receives the required power from the vehicle 3A and the required power from the vehicle 3B.

The supply device 5 determines whether or not the sum of the required power is larger than the suppliable power based on the required power received from the vehicle 3 traveling on the power supply lane 100 and the power of the AC power supply 6 (S102). In S102, the supply device 5 calculates the sum of the required power of the vehicle 3A and the required power of the vehicle 3B. Further, the supply device 5 calculates the suppliable power based on the power of the AC power supply 6. This calculation of the suppliable power may be performed prior to S102 or may be performed in S102. Then, the supply device 5 compares the sum of the required power and the suppliable power.

When it is determined that the sum of the required power is larger than the suppliable power (S102: Yes), the supply device 5 calculates the allocated power for each of the vehicles 3 (S103). In S103, the power allocated to the vehicle 3 is calculated on the basis of vehicle information such as the physique of the vehicle 3 and SOC of the battery 320 and the suppliable power corresponding to the power of the AC power supply 6. In the embodiment shown in FIG. 9, the supply device 5 calculates the allocated power to the vehicle 3A and the allocated power to the vehicle 3B by determining the distribution of the supplied power to the available power.

Then, the supply device 5 notifies the vehicle 3 traveling on the power supply lane 100 of the allocated power (S104). In S104, allocation power is notified from the supply device 5 to the vehicle 3 traveling in front of the supply section by using wide area radio communication. In this case, the supply device 5 determines that the suppliable power is smaller than the required power, and notifies the vehicle 3 traveling on the power supply lane 100 that the supply power by the supply device 5 is insufficient. The information indicating that the supplied power is insufficient may be the information itself indicating the allocated power to the vehicle 3, or may be information different from the information indicating the allocated power. When S104 process is performed, the control routine ends.

When it is determined that the sum of the required power is not larger than the suppliable power (S102: No), the supply device 5 notifies the vehicle 3 traveling on the power supply lane 100 that there is no issue regarding the power supply to the vehicle 3 (S105). In S105, information is transmitted from the supply device 5 to the vehicle 3 traveling in front of the supply section using wide area wireless communication. When S105 process is performed, the control routine ends.

According to the supply device 5 configured as described above, it is possible to notify the vehicle 3 of the allocated power. In the vehicle 3 that has received the notification of the allocated power, the driver confirms the notification, so that it is possible to recognize in advance that the supply power of the supply device 5 is insufficient in the power supply section to be entered.

In addition, in a case where the power supply is restricted in the area where the power supply lane 100 is provided, the power of the AC power supply 6 is restricted, and the power that can be supplied from the supply device 5 to the vehicle 3 is also restricted. Even in such a case, the supply device 5 is configured to appropriately distribute the supply power to the vehicle 3 traveling on the power supply lane 100.

Further, in the power supply lane 100, a plurality of supply devices 5 are arranged at predetermined intervals, and a plurality of power supply sections can be provided. For example, three supply devices 5 can be installed to form three feed zones. Each supply device 5 is provided with an AC power supply 6. Each supply device 5 notifies the vehicle 3 of information on the supplied power using wide area wireless communication before the vehicle 3 reaches its own power supply section.

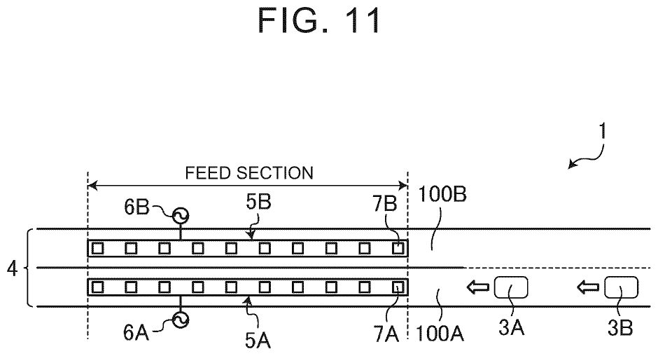

Further, the power supply lane 100 is not limited to a single lane, and may be formed in a plurality of lanes. As shown in FIG. 11, the power supply lane 100 includes a first power supply lane 100A and a second power supply lane 100B. When both the vehicle 3A and the vehicle 3B are traveling in the first power supply lane 100A, the first power supply lane 100A is the present lane, and the second power supply lane 100B is the other lane.

The first power supply lane 100A is provided with a first supply device 5A. The first supply device 5A has a plurality of first segmented 7A provided on the road 4. A first AC power supply 6A is electrically connected to the first supply device 5A. The power that can be supplied by the first supply device 5A is determined based on the power of the first AC power supply 6A.

The second power supply lane 100B is provided with a second supply device 5B. The second supply device 5B has a plurality of second segmented 7B provided on the road 4. A second AC power supply 6B is electrically connected to the second supply device 5B. The power that can be supplied by the second supply device 5B is determined based on the power of the second AC power supply 6B.

In the first power supply lane 100A and the second power supply lane 100B, the feeding section is provided at the same position in the lane of the road 4. The feed section formed by the first supply device 5A and the feed section formed by the second supply device 5B are formed at the same length and at the same lane position. Therefore, the vehicle 3 can supply power from either one of the first power supply lane 100A and the second power supply lane 100B.

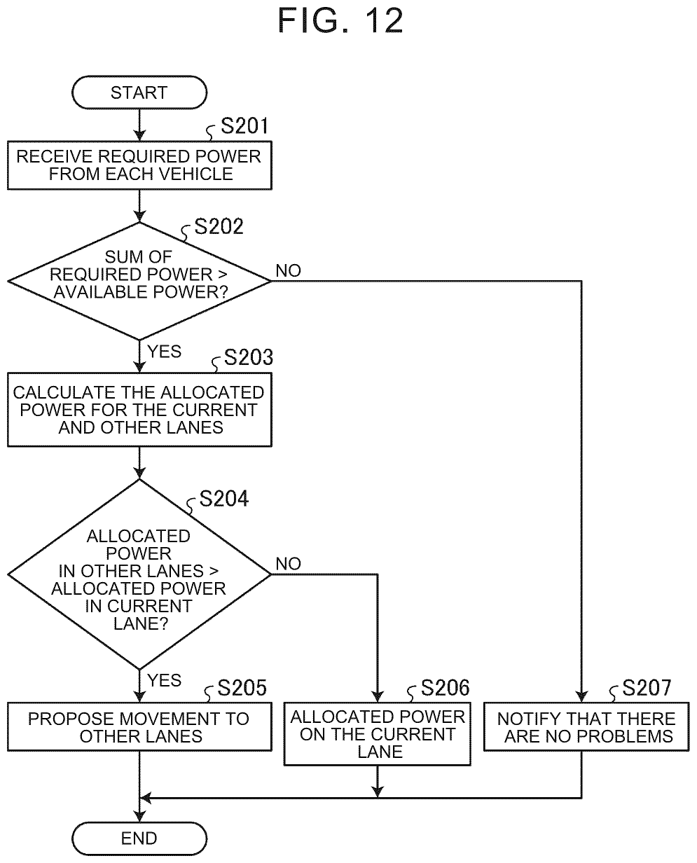

FIG. 12 is a flow chart illustrating a control flow when the power supply lane is a plurality of lanes. The control shown in FIG. 12 is performed by the supply device 5. It should be noted that two vehicles 3A, 3B as shown in FIG. 11 travel in the first power supply lane 100A.

The supply device 5 receives the required power from the vehicles 3 traveling on the power supply lane 100 (S201). In S201, the first power supply lane 100A receives the required power transmitted by the first supply device 5A from vehicles 3A, 3B traveling several hundred meters before the first supply device 5A using wide area radio communication. The first supply device 5A receives the required power from the vehicle 3 which may enter its supply section. In the embodiment shown in FIG. 11, the first supply device 5A receives the required power from the vehicle 3A and the required power from the vehicle 3B.

The supply device 5 determines whether or not the sum of the required power is larger than the suppliable power based on the required power received from the vehicle 3 traveling on the power supply lane 100 and the power of the AC power supply 6 (S202). In S202, the first supply device 5A calculates the sum of the required power of the vehicle 3A and the required power of the vehicle 3B. Further, the first supply device 5A calculates the suppliable power based on the power of the first AC power supply 6A. This calculation of the suppliable power may be performed prior to S202 or may be performed in S202. Then, the first supply device 5A compares the sum of the required power and the suppliable power.

If it is determined that the sum of the required power is larger than the suppliable power (S202: Yes), the supply device 5 calculates the allocated power in the present lane to the vehicle 3 and the allocated power in the other lane to the vehicle 3 (S203). In S203, the power allocated to the vehicle 3 is calculated on the basis of vehicle information such as the physique of the vehicle 3 and SOC of the battery 320 and the suppliable power corresponding to the power of the AC power supply 6. In the embodiment shown in FIG. 11, the first supply device 5A calculates the allocated power in the first power supply lane 100A to the vehicles 3A, 3B on the basis of vehicle information such as the physique of the vehicles 3A, 3B traveling in the first power supply lane 100A, and SOC of the battery 320, and the suppliable power corresponding to the power of the first AC power supply 6A. The first supply device 5A determines the distribution of the supply power to the suppliable power to calculate the allocated power to the vehicle 3A and the allocated power to the vehicle 3B. Further, the second supply device 5B calculates the allocated power to the vehicles 3A, 3B at the second supply lane 100B on the basis of the vehicle information such as the physique of the vehicles 3A, 3B traveling on the first supply lane 100A and SOC of the battery 320 and the suppliable power corresponding to the power of the second AC power supply 6B. The second supply device 5B determines the distribution of the supply power to the suppliable power to calculate the allocated power to the vehicle 3A and the allocated power to the vehicle 3B. The second supply device 5B transmits the calculated allocated power to the server 30. The server 30 transmits the allocated power received from the second supply device 5B to the first supply device 5A. The allocated power calculated by the second supply device 5B is transmitted to the first supply device 5A via the server 30 using wide area radio communication. The first supply device 5A can acquire the allocated power in the other lanes by acquiring the information on the allocated power calculated by the second supply device 5B from the server 30.

The supply device 5 determines whether the allocated power in the other lanes is larger than the allocated power in the present lane (S204). In S204, the first supply device 5A determines whether or not the allocated power in the second supply lane 100B, which is another lane, is larger than the allocated power in the first supply lane 100A, which is the present lane, for the vehicles 3A, 3B.

If it is determined that the allocated power in the other lane is greater than the allocated power in the present lane (S204: Yes), the supply device 5 suggests the vehicle 3 to move to the other lane (S205). In S205, the first supply device 5A transmits, to the vehicles 3A, 3B traveling on the first supply lane 100A, information suggesting a lane change to the second supply lane 100B. This information is transmitted by wide area wireless communication. When S205 process is performed, the control routine ends.

When it is determined that the allocated power in the other lane is not larger than the allocated power in the current lane (S204: No), the supply device 5 notifies the vehicle 3 traveling in the power supply lane 100 of the allocated power in the current lane to the vehicle 3 (S206). In S206, the vehicle 3 traveling in front of the supply section of the first power supply lane 100A is notified of the allocated power in the first power supply lane 100A. This notification is made by wide area wireless communication. When S206 process is performed, the control routine ends.

When it is determined that the sum of the required power is not larger than the suppliable power (S202: No), the supply device 5 notifies the vehicle 3 that there is no issue regarding the power supply to the vehicle 3 (S207). In S207, the vehicle 3 traveling in front of the supply section of the first power supply lane 100A is notified that there is no trouble. This notification is made by wide area wireless communication. When S207 process is performed, the control routine ends.

As described above, according to the embodiment, it is possible to notify the vehicle 3 traveling on the power supply lane 100 in advance of the allocated power corresponding to the required power of the vehicle 3 and the power that can be supplied by the supply device 5 on the ground side. In the vehicle 3 that has received the notification of the allocated power, the driver confirms the notification, and thus it is possible to know in advance that the supply power of the supply device 5 is insufficient in the power supply section to be entered.

S203 to S206 processes shown in FIG. 12 may be performed by the server 30. If a positive determination is made in S202, the supply device 5 transmits a request for calculating the allocated power in the present lane and the other lanes to the server 30. Upon receiving the calculation request from the supply device 5, the server 30 performs S203 process. In S203, the server 30 calculates the power allocated to the vehicle 3 on the basis of the vehicle information such as the physique of the vehicle 3 and SOC of the battery 320 and the suppliable power corresponding to the power of the AC power supply 6. In S204, the server 30 determines whether or not the allocated power in the second power supply lane 100B, which is another lane, is larger than the allocated power in the first power supply lane 100A, which is the present lane, with respect to the vehicles 3A, 3B. Then, in S205, the server 30 transmits, to the vehicles 3A, 3B traveling on the first power supply lane 100A, the data suggesting the lane change to the second power supply lane 100B. In addition, in S206, the server 30 notifies the vehicle 3 traveling in front of the supply section of the first power supply lane 100A of the allocated power in the first power supply lane 100A.

What is claimed is:

1. A supply device comprising:
a power transmission device that includes a primary coil provided in a road and transmits power to a vehicle traveling on the road in a non-contact manner; and
a control device on a ground side that controls the power transmission device, wherein
the control device is configured to:
compare required power for the vehicle traveling in a power supply lane provided with the primary coil and suppliable power to be supplied by the power transmission device, and adjust distribution of supply power from the ground side to the vehicle based on a comparison result; and
notify the vehicle that the supply power from the ground side is insufficient when the suppliable power is less than the required power.

2. The supply device according to claim 1, wherein the control device is configured to:
when the required power is received from a plurality of vehicles traveling in the power supply lane, determine whether a sum of the required power is greater than the suppliable power; and
when it is determined that the sum of the required power is greater than the suppliable power, calculate allocated power for each vehicle and notify the vehicle of the allocated power.

3. The supply device according to claim 2, wherein:
the power supply lane includes a plurality of lanes; and
the control device is configured to
when it is determined that the sum of the required power is greater than the suppliable power, calculate allocated power for the vehicle in a current lane and allocated power for the vehicle in a different lane from the current lane,
when the allocated power in the different lane is greater than the allocated power in the current lane, transmit information that suggests a change to the different lane to the vehicle, and
when the allocated power in the different lane is less than or equal to the allocated power in the current lane, notify the vehicle of the allocated power in the current lane.

4. The supply device according to claim 1, wherein the control device is configured to set distribution of the supply power based on a physical size of the vehicle and a state of charge (SOC) of a battery mounted on the vehicle.
